(19) United States
(12) Patent Application Publication
(10) Pub. No.: US 2026/0346121 A1
(43) Pub. Date: Nov. 5, 2026

(54) DICLANO CHESS CLOCK DEVICE

(71) Applicants: Nikash Vemparala, Redmond, WA (US); Srikant Vemparala, Redmond, CA (US)

(72) Inventors: Nikash Vemparala, Redmond, WA (US); Srikant Vemparala, Redmond, CA (US)

(21) Appl. No.: 19/378,851

(22) Filed: Nov. 4, 2025

Related U.S. Application Data
(60) Provisional application No. 63/715,900, filed on Nov. 4, 2024.

(51) Int. Cl. A63F 3/02; A63F 3/00; G06V 10/82; H04N 21/2187

(52) U.S. Cl. CPC A63F 3/022; A63F 3/00643; G06V 10/82; H04N 21/2187; A63F 2003/00662; A63F 2250/1084; A63F 2300/1075; A63F 2300/1093

(57) ABSTRACT

The diclano chess clock device integrates a power system, processing subsystem, sensor subsystem, user interface subsystem, connectivity subsystem, and security subsystem to enable automated capture, timing, and streaming of over-the-board chess games using standard tournament equipment. The integrated chess game capture and streaming method coordinates initialization, independent power domain activation, camera calibration, move event detection, computer vision-based piece recognition, and real-time AI commentary generation. The diclano chess clock device streams annotated video and structured game data, manages tournament operations including automated pairing and anti-cheating analysis, and optimizes power consumption for reliable operation. The diclano chess clock device eliminates the need for proprietary boards or complex setups, providing a unified solution for live broadcasting, data recording, and tournament management, thereby addressing the challenges of cost, compatibility, and automation in physical chess event coverage.

### CROSS REFERENCE TO A RELATED PATENT APPLICATION

This utility application claims the priority and benefit of application 63/715,900 filed on Nov. 4, 2024 the contents of which are incorporated herein as if restated herein.

### BACKGROUND

Over-the-board chess games have historically faced significant challenges in the systematic recording and streaming of gameplay. Traditional methods for documenting chess games, such as manual notation or post-game transcription, are labor-intensive and prone to human error. As a result, a substantial portion of valuable chess data is lost, limiting opportunities for subsequent educational use, in-depth analysis, and potential monetization. The absence of reliable and automated capture mechanisms has hindered the preservation and dissemination of over-the-board chess content.

Live broadcasting of chess events has typically relied on setups involving multiple cameras, specialized equipment, and dedicated camera crews. These requirements introduce considerable logistical complexity and financial burden, rendering live streaming impractical for the majority of chess tournaments, especially those at the amateur or local level. The high costs and technical demands associated with such broadcasting solutions have restricted widespread adoption and limited the reach of live chess content.

Smart chess boards have been developed to facilitate digital capture of over-the-board games; however, many of these systems require proprietary pieces or boards that are incompatible with standard tournament equipment. The need for specialized hardware and complex setup procedures creates barriers to integration within existing tournament infrastructures. This incompatibility and operational complexity have impeded the widespread use of smart chess boards in official events.

Integrating precise chess timing with additional functionalities such as camera operation, wireless connectivity, and display output presents further technical challenges. Power-intensive components can compromise battery life, while the simultaneous operation of timing and auxiliary functions may affect the reliability and accuracy of chess clocks. These conflicts between power management and timing precision have not been adequately addressed in existing systems.

Real-time artificial intelligence commentary and analysis for physical chess events remain largely unavailable in current solutions. While digital platforms can provide automated analysis for online games, there is no integrated system capable of generating and delivering AI-driven commentary and insights during live, over-the-board chess matches. The lack of such capabilities limits the educational and entertainment value of physical chess events for both participants and spectators.

Tournament management processes, including player pairing, result entry, bulletin creation, and anti-cheating measures, are predominantly manual in nature. These tasks are labor-intensive and susceptible to human error, leading to inefficiencies and inconsistencies in tournament administration. The absence of automation in these areas increases the workload for organizers and can negatively impact the overall quality and integrity of chess competitions.

Opportunities for monetization through sponsored streams, educational content, and pay-per-view access have not been fully realized in the context of over-the-board chess. The lack of automated tools for capturing, distributing, and enhancing chess content has limited the ability of organizers and content creators to generate revenue from live events. As a result, potential commercial benefits associated with chess broadcasting and content creation remain largely untapped.

### SUMMARY

The diclano chess clock device and the integrated chess game capture and streaming method together provide a comprehensive system for automated, real-time capture, analysis, and broadcast of over-the-board chess games. The diclano chess clock device integrates a power system with independent battery domains, a processing subsystem, a sensor subsystem including a camera module, a user interface subsystem, a connectivity subsystem, and a security subsystem. The integrated chess game capture and streaming method coordinates device initialization, move timing, computer vision-based move recognition, data processing, live streaming, AI-driven commentary, tournament management, and power optimization. This combination enables seamless, reliable, and scalable digitization and dissemination of physical chess events without requiring specialized boards or manual intervention.

The diclano chess clock device and the integrated chess game capture and streaming method address the problem of unrecorded over-the-board chess games by providing automated, high-fidelity capture of both move data and video. The sensor subsystem's camera module, in conjunction with the processing subsystem's streaming single-board computer, enables the recognition of piece positions via computer vision and the triggering of frame capture on move events. The integrated chess game capture and streaming method processes this data to generate a comprehensive game record dataset and a live annotated video stream, ensuring that valuable educational, analytical, and commercial data is preserved and accessible. This approach improves upon prior art by eliminating the need for manual notation or external recording devices.

The diclano chess clock device eliminates the need for expensive camera crews and specialized broadcasting equipment by integrating a camera module, a streaming single-board computer, and a connectivity subsystem with a wi-fi module directly into the chess clock. The integrated chess game capture and streaming method automates the streaming of video and metadata, encoding video streams and transmitting them to cloud services. This self-contained solution reduces operational costs and complexity, making live broadcasting practical for a wide range of tournaments, including those with limited resources.

The diclano chess clock device overcomes the limitations of smart chess boards that require proprietary pieces or boards by employing computer vision algorithms within the streaming single-board computer to recognize standard chess pieces and board configurations. The camera module captures board images, and the processing subsystem generates a board state map without the need for specialized hardware. This compatibility with standard tournament equipment simplifies setup and broadens applicability, representing a significant improvement over prior systems that demand proprietary components.

The diclano chess clock device resolves conflicts between precise chess timing and power-intensive streaming functions through the use of a power system with independent battery domains and power management circuitry. The clock domain battery pack ensures uninterrupted timing accuracy, while the streaming and display domain battery pack support high-power operations such as video capture and wireless transmission. The integrated chess game capture and streaming method further optimizes power and resources by monitoring battery and temperature telemetry, modifying operations to conserve power, and predicting remaining runtime. This architecture maintains timing reliability while supporting advanced features, surpassing prior art that suffers from battery life and timing conflicts.

The diclano chess clock device and the integrated chess game capture and streaming method provide an integrated solution for real-time AI commentary and analysis generation. The processing subsystem, leveraging the streaming single-board computer, executes steps to evaluate positions with a chess engine, generate natural language commentary, and create highlight clips. The method produces AI commentary and highlight assets, which are incorporated into the live annotated video stream. This real-time, automated analysis capability is not present in existing solutions, which typically require post-game processing or manual input.

The diclano chess clock device and the integrated chess game capture and streaming method automate tournament management tasks that are traditionally manual and error-prone. The method stores and manages tournament data, performs automated pairing and scheduling, and executes anti-cheating analysis using cloud-synchronized game assets. The system generates products such as next-round pairings schedule and cheating analysis report, reducing administrative workload and improving accuracy compared to manual processes.

The diclano chess clock device and the integrated chess game capture and streaming method unlock new monetization opportunities by automating the capture, annotation, and distribution of chess content. The system generates live annotated video stream, comprehensive game record datasets, and AI commentary and highlight assets, which can be used for sponsored streams, educational content, and pay-per-view offerings. This automated pipeline enables scalable content creation and distribution, addressing the unrealized commercial potential of over-the-board chess events.

### BRIEF DESCRIPTION OF FIGURES

FIG. 1 is a schematic representation of various disclosed systems and methods.

FIG. 2 is a schematic representation of various disclosed systems and methods

Reference numbers include:
100 Battery Domain 1, sometimes referred to as a clock domain and/or battery pack 1
105 physical buttons
107 GPIO input
110 Timing MCU
113 Timing signals
115 RTC
117 Time and button state
120 time setting
200 Battery Domain 2, sometimes referred to as a clock domain and/or battery pack 2
205 Environmental Sensors
207 Camera Subsystems
210 ENV Data
212 Video Frames
220 Streaming Controller such as a Raspberry Pi
222 touch input
225 UI input
227 streaming data
230 Display such as LCD/OLED touch
235 WiFi/Coud
240 Timing Controller such as a SAMD21 and RTC

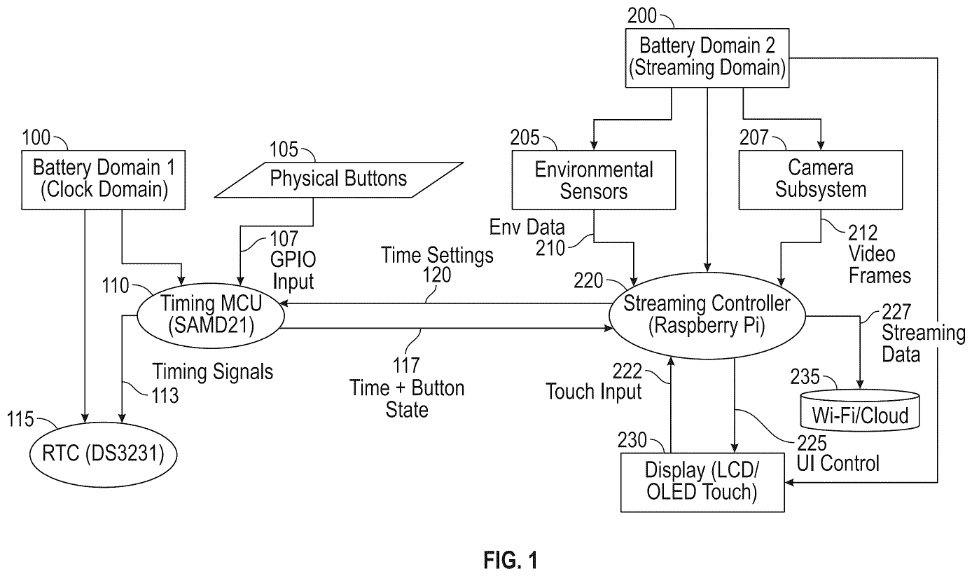

Referring to FIG. 1, a chess clock architecture may include a dual-domain power and signal architecture that may include:
a)—Battery Domain or pack 1 (Clock Domain) powers the Timing MCU (SAMD21) and RTC (DS3231).
b)—Battery Domain or pack 2 (Streaming Domain) powers the Streaming Controller (Raspberry Pi),
c) display subsystem, Camera Subsystem, and Environmental Sensors.

The Timing MCU handles physical button presses and RTC timekeeping, communicates button/timing info to the Streaming Controller, and receives time-setting commands.

The Streaming Controller manages the display/touch interface, environmental adjustments for power efficiency, camera video input, and cloud connectivity.

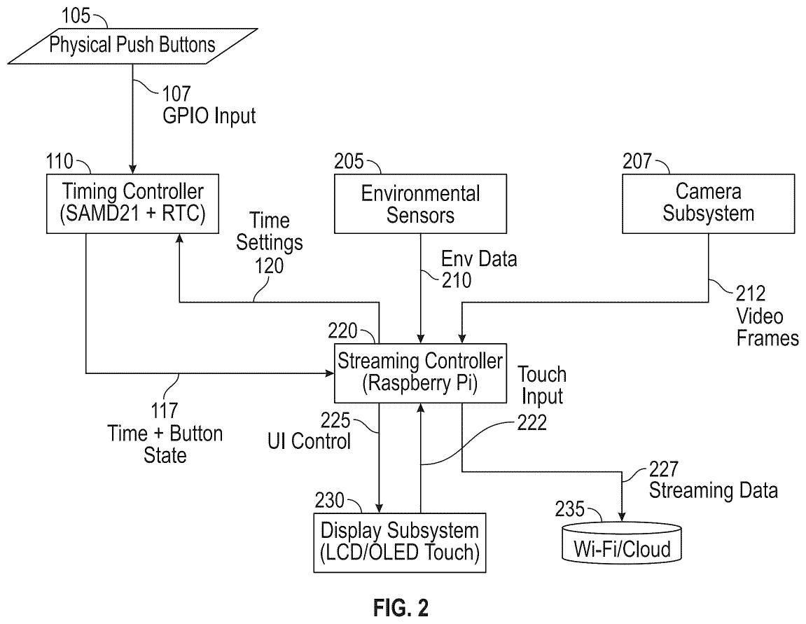

Referring to FIG. 2, the diagram emphasizes logical data/control flow.

Physical Buttons connect to the Timing Controller, which reports timing and button states to the Streaming Controller.

The Streaming Controller drives the display subsystem and receives user input via touchscreen.

Environmental Sensors provide telemetry for power/display optimization.

The Camera Subsystem provides video frames for streaming and analysis.

The Streaming Controller integrates all subsystems and communicates externally via Wi-Fi/Cloud for real-time streaming and synchronization.

### DETAILED DESCRIPTION

The disclosed embodiments, sometimes referred to as the diclano chess clock device may integrate classical chess timing with digital capture, processing, and communication subsystems within a portable table-top enclosure. Generally, the diclano chess clock device can implement a dual-domain power architecture, wherein a first power domain supplies a timing microcontroller and a real-time clock chip for chess timing operations, and a second electrically isolated power domain supplies a streaming single-board computer, a camera module, a connectivity subsystem, and a display subsystem. More specifically, the diclano chess clock device can present a conventional dual-display chess clock form factor with user-facing physical push buttons and timing displays while the enclosure houses a Raspberry Pi 4 Model B or an equivalent ARM-based processor and a SAMD21G18A-class timing microcontroller for video capture, real-time streaming, and user interface control. Additionally, the diclano chess clock device can position a high-resolution camera module to capture a chessboard and surrounding area and can expose a touchscreen display for user interaction and system feedback. Furthermore, the diclano chess clock device can support 2.4 GHz and/or 5 GHz Wi-Fi network connectivity for cloud synchronization, live streaming, and remote management. In particular, the diclano chess clock device can maintain compatibility with standard tournament chess boards and pieces without board modifications or proprietary pieces. Also, the diclano chess clock device can include secure boot, cryptographic verification, and anti-tampering features to ensure data integrity and timing reliability. Then, the diclano chess clock device can enable automated game recording, live broadcasting, AI-powered commentary, and tournament management functions within a single portable enclosure. Alternatively, the diclano chess clock device can adopt a modular design that optionally integrates a third independent power domain dedicated to OLED display operation to support multiple display configurations and dynamic power management. Finally, the diclano chess clock device can provide extended battery operation by coordinating intelligent power switching, load balancing, and predictive maintenance features for multi-day tournament use; therefore, the diclano chess clock device can address impractical over-the-board capture, high broadcast setup cost, proprietary smart board constraints, conflicts between precise timing and power-intensive streaming, and the absence of integrated AI analysis and tournament automation.

### Power System

The power system can implement a multi-domain electrical supply architecture that partitions energy delivery across isolated rails to support timing-critical and high-power streaming operations of the diclano chess clock device. More specifically, the power system can allocate at least two 18650 lithium-ion battery packs with exemplary nominal capacities between 3000 and 3600 mAh to form a timing domain that can supply the timing microcontroller, the real-time clock chip, and user interface components with low-power display elements, and a streaming domain that can supply the streaming single-board computer, the camera module, the connectivity subsystem, and a high-resolution display panel. Additionally, the power system can incorporate power management circuitry that continuously monitors battery charge levels, cell voltages, and temperature, performs cell balancing during charging cycles, and enforces over-discharge protection to extend service life; in one implementation, the power system can execute domain-selective shutdown to power down the streaming domain independently of the timing domain to preserve timing accuracy and extend runtime when streaming does not occur. Further, the power system can include a unidirectional logic-level interface that transmits consolidated timing and physical push button state information from the timing microcontroller to the streaming single-board computer while preventing any power transfer between domains, thereby preventing voltage sag or current surges on the timing rail during transient streaming loads such as video capture or wireless transmission. In one implementation, the power system can establish a third, independently managed display domain for the display subsystem (e.g., an OLED panel) to enable dynamic display switching and to further optimize power consumption; in another implementation, the power system can execute predictive power management algorithms that adjust subsystem activity in response to real-time battery status, operational context, and tournament scheduling constraints. Also, the power system can support simultaneous charging of all battery packs via dedicated charging circuits that provide over-voltage protection, thermal monitoring, and charge balancing, and the architecture can accommodate single- or multi-battery configurations to adapt to variant requirements across deployments. Thus, the power system can segregate timing and streaming energy demands, can maintain timing reliability under burst loads, and can extend operating time and safety, thereby addressing conflicts between precise chess timing and power-intensive camera, connectivity, and display functions.

### Clock Domain Battery Pack

The clock domain battery pack can supply exclusive electrical power to the timing microcontroller and the real-time clock chip while also energizing the physical push buttons and a subset of the display subsystem that supports timing indications, thereby isolating timekeeping loads from other domains. More specifically, the clock domain battery pack can couple to power management circuitry through ultra-low-dropout regulators to maintain a regulated rail within a tolerance that supports microsecond-accurate clock generation by the timing microcontroller over multi-day operation. In particular, the clock domain battery pack can allocate a dedicated 18650 lithium-ion cell with an exemplary capacity between 3000 mAh and 3500 mAh per cell to deliver continuous runtime for tournament sessions without dependence on the streaming single-board computer or the camera module. Additionally, the real-time clock chip can preserve wall-clock accuracy when the clock domain battery pack coordinates with power management circuitry to transition to a backup CR2032 coin-cell during primary cell depletion or hot-swap events. Also, the clock domain battery pack can integrate protection functions via power management circuitry to limit over-discharge, over-current, and thermal excursions while generating battery and temperature telemetry for supervisory logic. Furthermore, the clock domain battery pack can support hot-swappable battery cage and tool-less removable cartridge variants to enable field replacement without interruption of timing microcontroller operations. Alternatively, the clock domain battery pack can implement a single-cell 18650 variant, a dual-cell parallel variant, a dual parallel 18650 pack, a lithium-polymer slimline variant, or a lifepo 4 safety-optimized variant to balance volumetric constraints and safety profiles, and the clock domain battery pack can incorporate a supercapacitor-assisted burst variant or an inductive-charging enabled variant for rapid transitions between active and standby. Then, the clock domain battery pack can route isolated ground and supply returns that decouple high-current transients originating from the streaming domain battery pack and the display domain battery pack to prevent jitter injection into the timing microcontroller and the real-time clock chip. Finally, the clock domain battery pack can expose connectors and/or harnesses that allow the power management circuitry to gate, measure, and report domain-specific state while the display subsystem renders minimal timing indicators under low-power constraints. Therefore, the clock domain battery pack addresses conflicts between precise chess timing and power-intensive capture and streaming functions by isolating the timing electronics from fluctuating loads, by sustaining accurate timing during battery replacement, and by maintaining a stable, domain-dedicated power budget for reliable tournament operation.

### Streaming Domain Battery Pack

The streaming domain battery pack can provide isolated electrical power to the streaming single-board computer, the camera module, and the connectivity subsystem to support continuous operation for at least several hours, including sustained 4K video capture and real-time streaming under worst-case workloads. The streaming domain battery pack can include one or more 18650-format lithium-ion cells arranged in a single-cell 18650 variant or a dual-cell parallel variant to deliver peak discharge currents in an exemplary range of 5-15 A and average discharge currents in an exemplary range of 1-5 A suitable for encoding bursts and wireless transmission. The streaming domain battery pack can connect through dedicated high-current rails that maintain electrical isolation from the clock domain battery pack to prevent load-induced voltage fluctuations from affecting the timing microcontroller and the real-time clock chip. The streaming domain battery pack can interface with power management circuitry that performs fast charging, real-time state-of-charge estimation, passive or active cell balancing, and thermal management across charge and discharge cycles. The streaming domain battery pack can request thermal throttling by signaling the power management circuitry to reduce charging or discharging rates in response to temperature feedback from embedded thermistors and/or the environmental sensor module, thereby protecting cell longevity and device safety. The streaming domain battery pack can support a hot-swappable battery cage and/or a tool-less removable cartridge to enable uninterrupted operation while an operator replaces a depleted module without interrupting the streaming single-board computer session. The streaming domain battery pack can operate in parallel with an additional module to extend runtime or to share peak currents according to a dual parallel 18650 pack configuration that employs active ideal-diode ORing and/or passive current sharing. The streaming domain battery pack can implement an inductive-charging enabled variant to accept wireless charging when the diclano chess clock device remains active between rounds to simplify venue logistics. The streaming domain battery pack can provide voltage regulation headroom that accommodates DC-DC converters for the streaming single-board computer and the camera module while maintaining conversion efficiency across an exemplary input range of 3.0-4.2 V per cell and an exemplary pack capacity of 20-40 Wh. The streaming domain battery pack can selectively power a high-brightness element of the display subsystem in configurations that omit the display domain battery pack while default configurations allocate display power to the display domain battery pack to preserve modularity. The streaming domain battery pack can expose telemetry of pack voltage, current, and temperature to the power management circuitry to enable monitor battery and temperature operations and to support predicted runtime estimate generation during optimize power and resources procedures. Therefore, the streaming domain battery pack can sustain high-power streaming workloads, can isolate streaming loads from timing circuits, and can enable hot-swap and managed thermal behavior to address conflicts between continuous broadcasting and reliable chess timing in tournament environments.

### Display Domain Battery Pack

The display domain battery pack can supply an electrically isolated power rail exclusively to the display subsystem and can maintain isolation from a timing microcontroller and a streaming single-board computer to prevent cross-domain disturbances. Generally, the display domain battery pack can power OLED panel, LCD panel, and/or e-ink panel, and the display domain battery pack can accommodate single-display and dual-display arrangements that exhibit high-variability luminance demands. More specifically, the display domain battery pack can include integrated battery management circuitry configured to monitor charge level, enforce over-discharge protection, and balance cells, and the display domain battery pack can regulate output to a target voltage range (e.g., 3.3-5.0 V via a DC-DC stage) while accepting a native cell voltage range (e.g., 2.7-4.35 V). In one implementation, the display domain battery pack can incorporate a rechargeable lithium-ion 18650 cell, and in another implementation, the display domain battery pack can include a lithium-polymer slimline pack and/or a Lifepo 4 chemistry to optimize energy density and safety. In yet another implementation, the display domain battery pack can adopt a single-cell 18650 variant, a dual-cell parallel variant, or a dual parallel 18650 pack to achieve capacity targets (e.g., 2000-7000 mAh) while maintaining the isolated rail. Additionally, the display domain battery pack can include a supercapacitor-assisted burst variant to absorb rapid current draws from OLED pixel activation without propagating voltage droop, and the display domain battery pack can support an inductive-charging enabled variant to permit sealed-enclosure charging. Further, the display domain battery pack can implement an independent charge/discharge path to enable hot-swappable battery cage and/or tool-less removable cartridge replacement without interrupting power in a clock domain battery pack or a streaming domain battery pack. In operation, the display domain battery pack can allocate power dynamically based on ambient lighting conditions, user-selected display modes, and remaining capacity by cooperating with power management circuitry to adjust brightness, refresh behavior, and/or panel duty cycling. Thus, the display domain battery pack isolates transient display loads, sustains high-contrast display operation, and preserves timing accuracy and streaming stability, which addresses conflicts between power-intensive display functions and timing reliability while supporting affordable, continuous over-the-board capture and streaming.

### Power Management Circuitry

The power management circuitry can orchestrate power generation, regulation, distribution, and protection across a clock domain battery pack, a streaming domain battery pack, and a display domain battery pack to establish independent power domains energized. The power management circuitry can include charge controller integrated circuits for each battery domain, solid-state load switches for selective rail connection, fuel gauge modules for real-time state-of-charge and health estimation, and DC-DC converters that regulate rails (e.g., 3.0-5.5 V outputs from 2.5-16 V inputs) with conversion efficiency above an exemplary 85-95% range. The power management circuitry can maintain electrical isolation between a timing microcontroller domain and a streaming single-board computer domain to suppress cross-domain interference and to limit voltage droop during 0.5-3.0 A transient loads associated with a camera module and a wi-fi module. The power management circuitry can execute activate independent power domains to soft-start rails with slew-controlled load switches and to sequence converters according to dependency rules that prevent backfeed and ground bounce. The power management circuitry can execute monitor battery and temperature to sample fuel gauge measurements at an exemplary 0.5-2.0 Hz rate, to fuse environmental sensor module temperature with cell measurements, and to publish battery and temperature telemetry to a processing subsystem. The power management circuitry can execute predict remaining runtime to compute a predicted runtime estimate based on coulomb count, open-circuit voltage, and a rolling load profile from a display subsystem and a streaming single-board computer. The power management circuitry can execute modify operations to conserve power to throttle a streaming single-board computer supply via dynamic voltage scaling, to dim an OLED panel or an LCD panel backlight via PWM duty adjustment, and to command a sensor subsystem to reduce camera module frame rate when battery thresholds or thermal thresholds cross configurable setpoints. The power management circuitry can implement dynamic load balancing to prioritize a timing microcontroller rail during streaming bursts by allocating converter current limits and by pre-charging rail capacitance to buffer surge loads. The power management circuitry can support seamless hand-off between domains by latching the clock domain rail during a streaming domain shutdown and by gating wake events that re-enable converters without disturbing track player time. The power management circuitry can manage a third display-specific domain by adjusting display brightness according to ambient readings from the environmental sensor module and by selectively disabling display rows or pixels during static content intervals to reduce average draw by an exemplary 20-60% range. The power management circuitry can provide safety by enforcing over-voltage, over-current, short-circuit, and thermal cutoff protections and by balancing charge across multiple packs during simultaneous charging to limit cell delta below an exemplary 10-50 mV range. The power management circuitry can interoperate with a hot-swappable battery cage and a tool-less removable cartridge by debouncing pack insertion, by pre-charging input capacitance through a controlled inrush path, and by isolating reverse conduction through ideal-diode controllers. The power management circuitry can communicate operational status and fault conditions to a processing subsystem and to a user interface subsystem to drive user notifications and to switch the power system into a power-optimized operating mode when required. Thus, the power management circuitry can prevent timing disruption during high-current streaming activity, can extend field runtime under tournament conditions, and can sustain reliable operation that addresses conflicts between precise chess timing and power-intensive capture, processing, and connectivity workloads.

### Processing Subsystem

The processing subsystem can implement a dual-processor architecture that separates deterministic chess timekeeping from multimedia and network processing to maintain reliable operation during variable computational load. Generally, the processing subsystem can include a timing microcontroller that executes chess timekeeping logic, interfaces with physical push buttons of the user interface subsystem, and coordinates with a real-time clock chip to maintain absolute time references. More specifically, the processing subsystem can include a streaming single-board computer that executes computer vision for recognizing piece positions via computer vision, renders user interface elements for the display subsystem, acquires frames from the camera module, communicates via the connectivity subsystem, and manages streaming protocol state for stream video and metadata. Additionally, the processing subsystem can operate the timing microcontroller independently of the streaming single-board computer so that track player time proceeds with deterministic accuracy regardless of the power state or software state of the streaming single-board computer. In one implementation, the processing subsystem can communicate between processors via a unidirectional or bidirectional logic-level interface, such as UART serial and/or GPIO signaling, to transmit consolidated timing data and user input states from the timing microcontroller to the streaming single-board computer. In another implementation, the processing subsystem can maintain ultra-low-power states for the timing microcontroller when the chess clock remains idle while selectively powering up or powering down the streaming single-board computer according to streaming or generate AI commentary and analysis requirements. Furthermore, the processing subsystem can preserve uninterrupted chess timing during high-load encode video stream operations, during transient network interruptions handled by transmit stream to cloud service, and during software faults that affect the streaming single-board computer. Alternatively, the processing subsystem can perform dynamic load balancing by offloading non-timing-critical supervisory tasks to the timing microcontroller under power-saving operational mode when the streaming single-board computer enters a reduced-power state. Also, the processing subsystem can support modular expansion so that an upgrade of the timing microcontroller and/or an upgrade of the streaming single-board computer proceeds without changes to the other processing domain. In one embodiment, the processing subsystem can configure firmware and inter-processor messaging to accommodate a range of chess timing modes and a range of streaming configurations while maintaining a consistent interface to downstream method steps. Therefore, the processing subsystem addresses conflicts between precise timekeeping and power-intensive capture and streaming by isolating timing from multimedia workloads, and the processing subsystem enables reliable over-the-board capture, real-time streaming, and analysis without compromising chess timing accuracy.

### Timing Microcontroller

The timing microcontroller may include a SAMD21G18A ARM Cortex-M0+ device that executes dedicated chess clock firmware to generate and maintain player timing states according to tournament parameters. The timing microcontroller can operate within an isolated power domain by drawing energy exclusively from a clock domain battery pack so that timing operations continue independently of a streaming single-board computer and a display subsystem. The timing microcontroller can interface with physical push buttons via GPIO lines and can perform hardware-level debouncing (e.g., 1-10 ms per edge) so that the timing microcontroller accurately recognizes player actuations under vibration and electrical noise. The timing microcontroller can implement time-control algorithms such as classical countdown, Fischer increment, Bronstein delay, and custom tournament modes by updating internal timing registers at sub-millisecond granularity (e.g., 0.1-1.0 ms tick) and by switching active players upon valid button events. The timing microcontroller can continuously monitor button actuation events to trigger state transitions such as player switch, pause, or adjudication hold, and the timing microcontroller can record event timestamps for later synchronization. The timing microcontroller can transmit consolidated timing data as structured digital packets over a unidirectional logic-level line to the streaming single-board computer at an event-driven or periodic rate (e.g., 10-50 Hz), and the streaming single-board computer can transmit one-time configuration commands such as initial time settings or mode selection to the timing microcontroller during setup. The timing microcontroller can minimize energy consumption by entering sleep modes between ticks with an average sleep current in an exemplary range of 5-50 μA and by waking on GPIO or timer interrupts to maintain responsiveness. The timing microcontroller can maintain absolute time continuity during main power interruptions by synchronizing with a real-time clock chip such as a DS3231 powered by a coin cell, and the timing microcontroller can periodically verify drift and apply correction factors. The timing microcontroller can preserve timing accuracy during concurrent imaging and networking loads by maintaining electrical and logical isolation from noise-generating subsystems such as a camera module, a wi-fi module, and the display subsystem, and the timing microcontroller can reject spurious line disturbances via input filtering and CRC-checked packet framing. Therefore, the timing microcontroller addresses conflicts between power-intensive streaming and precise chess timing by ensuring uninterrupted, low-noise, and verifiable timekeeping that enables the capture and time chess moves step without degrading reliability during simultaneous streaming and connectivity operations.

### Real-Time Clock Chip

The real-time clock chip may provide high-precision epoch time for chess timing operations and can utilize a temperature-compensated DS3231 architecture that maintains accuracy within ±2 ppm across an exemplary temperature range of −40 °C to +85 °C by employing an integrated crystal oscillator and a temperature sensor that automatically compensates temperature-induced drift. The real-time clock chip interfaces electrically with the timing microcontroller via an I2C bus to synchronize time, to set time, and to retrieve current time data, and the real-time clock chip can present alarm and interrupt outputs that the timing microcontroller can map to wake events and periodic timing triggers for capture and time chess moves. The real-time clock chip can source power from the power system during normal operation and can automatically switch to a backup CR2032 coin-cell battery to preserve timekeeping for an exemplary duration up to four years, which can permit hot-swap of a clock domain battery pack and/or maintenance of the power system without loss of time continuity. The real-time clock chip can mount on a main timing circuit board and can remain electrically isolated from the streaming single-board computer and the display subsystem by placement within a clock domain power rail and by use of decoupling and RC filtering to limit injection of high-current noise that could introduce timing jitter. Therefore, the real-time clock chip enables uninterrupted and accurate timing across temperature variation and power transitions, which addresses timing reliability conflicts that arise when the diclano chess clock device operates camera, connectivity, and display functions concurrently.

### Streaming Single-Board Computer

The streaming single-board computer can include a Raspberry Pi 4 Model B with a quad-core ARM Cortex-A72 processor and a memory capacity (e.g., about 4 GB) to execute concurrent pipelines for computer vision, video encoding, graphical rendering, and cloud synchronization. Generally, the streaming single-board computer can perform real-time computer vision to recognize chess piece positions and movements from input frames of the camera module, and the streaming single-board computer can encode video according to H.264 and/or H.265 while publishing live streams via RTSP and/or RTMP with optional local recording. More specifically, the streaming single-board computer can render a graphical user interface on a touchscreen display of the display subsystem while processing touch input and/or physical push button events conveyed via the timing microcontroller. In one implementation, the streaming single-board computer can manage bi-directional cloud synchronization by uploading structured game data, encoded video, and overlay metadata while receiving configuration updates, tournament pairings, and AI-generated commentary to drive on-device overlays. In particular, the streaming single-board computer can boot from a secure flash storage medium and can verify firmware via cryptographic signatures to prevent unauthorized modification. Additionally, the streaming single-board computer can employ GPU-accelerated image processing to offload compute-intensive filters and compositing to achieve low-latency encoding and efficient move recognition. In one embodiment, the streaming single-board computer can operate within an isolated power domain powered by a streaming domain battery pack, and the streaming single-board computer can communicate with the timing microcontroller over a unidirectional logic-level interface to receive consolidated timing and button state information without injecting noise into a clock domain. Alternatively, the streaming single-board computer can adjust processing loads and streaming quality dynamically based on battery status, network performance metrics, and operational requirements to maintain continuity of service. In another implementation, the streaming single-board computer can execute adaptive bandwidth management, environmental sensing integration with the environmental sensor module for context-aware overlays, and device health monitoring for predictive maintenance. Therefore, the streaming single-board computer addresses field challenges by enabling low-cost over-the-board capture and live distribution without external crews, by isolating timing and streaming power domains to preserve timing reliability, and by supporting real-time AI-driven overlays and tournament automation that expand data availability and monetization opportunities.

### Sensor Subsystem

A sensor subsystem can aggregate visual and environmental data streams to support chess move capture, board state analysis, and adaptive device operation. The camera module can provide a high-resolution imager (e.g., between 8 and 16 megapixels with a frame size between 1920×1080 and 4608×2592 pixels) and can position above a regulation board footprint to capture the entire board and a margin of surrounding area for move recognition and video streaming. The environmental sensor module can sense ambient temperature, ambient light level, and humidity and can publish telemetry that the processing subsystem can use to adjust display brightness, camera exposure, and cooling behavior. The sensor subsystem can interface with the streaming single-board computer via a Camera Serial Interface (CSI) for video and via Inter-Integrated Circuit (I2C) and/or Serial Peripheral Interface (SPI) for environmental data to support low-latency acquisition. The sensor subsystem can stream frames and measurements in real time so that the streaming single-board computer can execute recognize piece positions via computer vision, validate a board state map, and update streaming parameters without user intervention. The sensor subsystem can implement a modular form factor so that an operator can add or remove the camera module and/or the environmental sensor module to match venue requirements. The sensor subsystem can maintain electrical isolation from timing-critical domains of the timing microcontroller and the real-time clock chip to prevent interference with track player time functions. The sensor subsystem can execute firmware-based calibration routines on a scheduled basis to correct lens distortion, white balance drift, light sensor offset, and temperature sensor offset across varying conditions. Thus, the sensor subsystem enables automated over-the-board capture without proprietary boards, preserves timing accuracy via isolation, and improves stream quality and power adaptability via environment-aware control, which collectively address the cost, complexity, and reliability challenges of tournament broadcasting.

### Camera Module

The camera module can capture digital images of a chessboard according to a Pi camera module V3 class imager that provides approximately 12 megapixels (e.g., between 8 and 16 megapixels) at a native frame of 4608×2592 pixels and that includes autofocus optics configured to maintain piece-edge acuity under variable table distances. More specifically, the camera module can mount to the sensor subsystem in a top-down or angled orientation to provide an unobstructed field of view of the chessboard and adjacent move area, and the camera module can couple to the processing subsystem via a Camera Serial Interface (CSI) link to transfer raw or preprocessed frames with low latency (e.g., under 20 ms) and high throughput (e.g., 1-4 Gbit/s). In particular, the camera module can acquire video frames at a variable frame rate (e.g., 10-60 frames per second) that the processing subsystem can adjust based on system requirements, available network bandwidth, and remaining battery energy, and the camera module can expose driver controls that the processing subsystem can use to schedule short, high-rate bursts on move events. Additionally, the camera module can execute autofocus, auto-exposure, and white-balance control via embedded firmware and/or host-side routines to stabilize exposure under tournament lighting that exhibits flicker and mixed color temperature. Furthermore, the camera module can cooperate with computer vision algorithms running on the streaming single-board computer to detect chessboard boundaries, to identify piece positions, and to track move progression without specialized pieces or board modifications, and the camera module can provide region-of-interest crops and downscaled pyramids to accelerate recognition. Also, the camera module can output compressed frames according to a codec pipeline (e.g., MJPEG or H.264/H.265) to reduce uplink load for live streaming and archival storage while preserving fine piece contours required for recognition. Then, the camera module can enter a selectively powered-down or low-power standby state when the streaming single-board computer deactivates capture, and the camera module can support single-and multi-camera configurations to enable multi-angle coverage or collaborative recording across adjacent boards. Therefore, the camera module addresses the lack of affordable over-the-board capture and streaming by enabling unobtrusive, standard-equipment-compatible vision capture, by reducing reliance on camera crews through automated framing and exposure control, and by cooperating with power management to mitigate conflicts between imaging performance and battery-constrained timing operations.

### Environmental Sensor Module

Generally, the environmental sensor module can include a multi-sensor array configured to monitor environmental parameters in the vicinity of the diclano chess clock device and to provide those parameters to subsystems that adjust operation. More specifically, the environmental sensor module can include at least a temperature sensor and an ambient light sensor and can optionally include a barometric pressure sensor and/or a humidity sensor to broaden environmental context for analysis. In one implementation, the environmental sensor module can electrically interface with the streaming single-board computer via a digital serial bus, such as I2C or SPI, and can draw power from the streaming domain battery pack via power management circuitry of the power system. Additionally, the environmental sensor module can sample sensor data at a configurable rate (e.g., between 0.5 Hz and 10 Hz) and can transmit sampled records to the streaming single-board computer for logging and control. In narrower implementations, the environmental sensor module can include a digital temperature sensor, a photodiode-or phototransistor-based ambient light sensor, and a MEMS barometric pressure sensor to achieve low-power, board-level accuracy. Alternatively, the environmental sensor module can mount on a main PCB or can reside on a discrete daughterboard to enable mechanical isolation and ease of replacement. Also, the environmental sensor module can execute calibration routines and self-diagnostic tests to maintain accuracy across temperature and aging. For adaptive visuals, the environmental sensor module can provide real-time illuminance measurements to the display subsystem to enable automatic modulation of display luminance for visibility and power efficiency. For thermal protection, the environmental sensor module can report temperature readings to the processing subsystem to trigger processor throttling by the streaming single-board computer, to guide the adjust stream parameters based on conditions step toward reduced bitrate or frame rate, and to request a transition into a power-saving operational mode via the power management circuitry. For provenance, the environmental sensor module can supply environmental metadata that the streaming single-board computer can tag into the structured game data stream and/or the live annotated video stream to support store and manage tournament data operations and to inform execute anti-cheating analysis procedures. Thus, the environmental sensor module enables automatic brightness control and thermal-aware streaming to extend runtime while preserving timing reliability, and provides environmental context for fairness audits, which addresses conflicts between power, heat, and automated tournament-grade capture and distribution.

### User Interface Subsystem

The user interface subsystem can orchestrate hardware and software elements that facilitate interaction between users and the diclano chess clock device, and the user interface subsystem can minimize input-to-action latency by routing timing inputs through a direct hardware path to the timing microcontroller. More specifically, the user interface subsystem can couple physical push buttons to the timing microcontroller through interrupt-driven lines that process debounced edges within an exemplary 1-5 ms window to execute track player time while the user interface subsystem can present timing and status via the display subsystem using an LCD panel and/or an e-ink panel and optionally an OLED panel for enhanced visual output. Additionally, the user interface subsystem can accept capacitive touch input via a touch interface to enable configuration, tournament management, and streaming operations while the user interface subsystem can render multi-language output and generate audio feedback for accessibility. In one implementation, the user interface subsystem can optimize display visibility by driving adaptive brightness across an exemplary 50-800 nit range, by performing selective pixel activation when the display subsystem includes an OLED panel, and by executing dynamic display mode switching between high-refresh and low-refresh states to reduce power. In another implementation, the user interface subsystem can adjust interface layouts and control schemes according to operational context, detected user role, and/or accessibility needs, and the user interface subsystem can surface role-specific controls for organizers, players, and technical staff. Furthermore, the user interface subsystem can maintain electrical and logical partitioning that isolates timing-critical input and display functions from the streaming single-board computer and the connectivity subsystem so that the user interface subsystem preserves timing accuracy during high-load stream video and metadata operations while operating from the display domain battery pack independent of the streaming domain battery pack under control of power management circuitry. Therefore, the user interface subsystem addresses the technical challenges by preserving precise timing during concurrent streaming, by reducing setup complexity through integrated controls, and by extending battery life via adaptive rendering and power-aware modes, which collectively enable reliable capture, analysis, and distribution of over-the-board chess without specialized crews or proprietary boards.

### Display Subsystem

The display subsystem can provide a modular visual interface assembly that delivers user interaction and status feedback for the diclano chess clock device. Generally, the display subsystem can interface an LCD panel via a Display Serial Interface link to drive low-latency graphical updates for chess timing and streaming status. More specifically, the display subsystem can accept capacitive touch input to enable a user to configure clock parameters, initiate or terminate streaming sessions, and navigate tournament management features through on-device controls. Alternatively, the display subsystem can support an OLED panel and/or an e-ink panel to adapt color performance and power consumption profiles to venue requirements. In one implementation, the power management circuitry can manage an independent power domain of the display subsystem, and the display domain battery pack can supply regulated energy to decouple display load transients from timing-critical circuitry. Additionally, the environmental sensor module can provide ambient light measurements, and the display subsystem can execute automated brightness control algorithms to adjust luminance for visibility and energy efficiency. Further, the power management circuitry can schedule selective activation, dimming, or deactivation of display elements according to battery and temperature telemetry and according to a power-saving operational mode. In one embodiment, the display subsystem can switch between panel types and operational modes without interrupting execution of the timing microcontroller and without interrupting execution of the streaming single-board computer. In a hybrid dual-display configuration, the display subsystem can present dynamic information on an LCD or OLED panel while maintaining persistent timing data on an e-ink panel to balance readability and energy draw. In certain variants, the display subsystem can maintain physical and electrical isolation with dedicated cabling and regulation so that the display subsystem prevents display-related noise from coupling into the timing microcontroller. Additionally, the diclano chess clock device can integrate the display subsystem with enclosure features that provide mechanical support and routed harnesses to reduce electromagnetic interference and user disruption during gameplay. Thus, the display subsystem can reduce power conflicts with precise timing, can preserve reliable operation during streaming, and can streamline local control to alleviate the lack of practical, integrated over-the-board capture and management tools.

### Connectivity Subsystem

Generally, the connectivity subsystem can establish, maintain, and secure wireless communication links between the diclano chess clock device and external networks to execute establish network connectivity and to enable stream video and metadata. More specifically, the connectivity subsystem can coordinate a wi-fi module that supports IEEE 802.11ac dual-band (2.4 GHz and 5 GHz) operation to transport high-throughput payloads for live annotated video stream generation, structured game data stream synchronization, and remote tournament management workflows. In particular, the connectivity subsystem can orchestrate adaptive bitrate control by instructing the streaming single-board computer to adjust encode video stream parameters and to regulate transmit stream to cloud service rates according to real-time assessments of available bandwidth, received signal strength, and packet error measurements. Additionally, the connectivity subsystem can optionally provide Bluetooth Low Energy capability to pair with external sensors, user authentication tokens, and/or auxiliary input devices while the security subsystem and the connectivity subsystem can jointly enforce WPA2/WPA3 link protection, end-to-end encryption for cloud communications, and device authentication before permitting data routing. Also, the connectivity subsystem can manage networks by selecting optimal access points based on scanned channel occupancy, by buffering and resuming data transfer during interruptions, and by emitting network performance metrics for diagnostics that the streaming single-board computer can consume to adjust stream parameters based on conditions. Furthermore, the connectivity subsystem can interface directly with the streaming single-board computer via a high-speed host interface and can run dedicated software modules that schedule network selection, maintain connection keep-alives, and route video and metadata traffic for streaming, synchronization, and remote management operations. Thus, the connectivity subsystem can address unreliable or congested venue networking, reduce setup complexity versus camera-crew deployments, and enable continuous low-latency distribution of captured games and analysis, which collectively mitigates the lack of practical, automated capture and broadcasting for over-the-board chess events.

### Security Subsystem

The security subsystem can implement hardware and software mechanisms configured to detect, record, and report unauthorized physical and logical access events within the diclano chess clock device, and the security subsystem can continuously sample enclosure tamper sensors to monitor for opening or manipulation of the device housing. The security subsystem can latch a tamper event in non-volatile memory upon detection of an enclosure breach, and the security subsystem can maintain persistence of a tamper record across power loss or device reset to preserve forensic integrity. The security subsystem can execute firmware integrity verification routines that perform cryptographic checks on system firmware at boot and during runtime, and the security subsystem can validate a digital signature and/or compare a cryptographic hash to a trusted value before the streaming single-board computer executes application code. The security subsystem can record a firmware modification event in non-volatile memory when a validation failure occurs, and the security subsystem can initiate a notification protocol that gates further functionality of the streaming single-board computer until a recovery workflow completes. The security subsystem can monitor timing manipulation by sampling output of the real-time clock chip and timing microcontroller for unexpected time jumps, clock resets, or inconsistent timing signals, and the security subsystem can correlate multiple timing sources to detect drift exceeding an exemplary threshold (e.g., 1-100 ms over 1-60 s). The security subsystem can generate an alert for any detected security event, and the security subsystem can transmit a notification over the connectivity subsystem and the wi-fi module to a remote tournament management system and/or to authorized tournament directors. The security subsystem can include anti-tamper switches, intrusion detection circuits, and secure boot mechanisms to prevent execution of unauthorized code, and the security subsystem can enforce a measured-boot sequence that binds configuration to a device-unique key stored in non-volatile memory. The security subsystem can log security events with time stamps derived from the real-time clock chip and with device identifiers managed by the processing subsystem, and the security subsystem can store event records with sequence numbers to support auditability and post-event analysis. The security subsystem can operate autonomously and independently of the streaming single-board computer and the timing microcontroller by drawing minimal power from a selected power domain and by running a dedicated supervisory routine, and the security subsystem can maintain event monitoring during reduced-power states of other device subsystems. The security subsystem can expose a read-only query interface to the store and manage tournament data workflow for authorized retrieval, and the security subsystem can rate-limit or deny queries from unauthorized requesters to reduce information leakage risk. The security subsystem can throttle alert transmission frequency according to network performance metrics received from the transmit stream to cloud service operation, and the security subsystem can buffer alerts locally when the connectivity subsystem reports a loss of the network connectivity established configuration. The security subsystem therefore mitigates timing manipulation and unauthorized changes that could undermine reliable capture, streaming, and tournament integrity, which addresses accuracy of chess timing under power constraints and supports automated anti-cheating analysis without adding manual workload.

### Integrated Chess Game Capture and Streaming Method

Generally, the diclano chess clock device can execute the integrated chess game capture and streaming method by initializing hardware subsystems, establishing network connectivity, capturing and interpreting over-the-board moves, and generating live and archived content for distribution and management. In one implementation, the integrated chess game capture and streaming method can start when the power management circuitry activates independent power domains and when the processing subsystem performs a self-test of a timing microcontroller, a real-time clock chip, a camera module, a display subsystem, and a connectivity subsystem while the connectivity subsystem authenticates to a cloud endpoint and synchronizes a tournament parameters manifest. More specifically, the timing microcontroller can track player time and generate a move event indicator while the camera module acquires a captured board image at scheduled intervals and/or in response to the move event indicator so that the streaming single-board computer can recognize piece positions via computer vision without specialized boards and can fuse timing data with visual detections into a structured game data stream. In one embodiment, the streaming single-board computer can encode video stream content with an overlay metadata snippet and can transmit a live annotated video stream to a cloud service while the streaming single-board computer can adjust an active streaming parameter set according to battery and temperature telemetry, network performance metrics, and a detected game phase. Additionally, the streaming single-board computer can generate AI commentary and highlight assets by evaluating a position with a chess engine, producing a natural-language commentary block, and creating a highlight clip package, and the streaming single-board computer can store and manage tournament data to build a comprehensive game record dataset for later retrieval. Then, the connectivity subsystem can upload cloud-synchronized game assets for automated pairing, scheduling, and anti-cheating analysis while the power system can optimize power and resources to preserve timing accuracy and maintain uninterrupted broadcasting. Thus, the diclano chess clock device addresses loss of over-the-board data, costly multi-device broadcast setups, incompatibility with standard tournament equipment, conflicts between precise timing and high-power streaming, absence of real-time AI commentary, manual tournament administration burdens, and unrealized monetization by providing an integrated pathway from capture to analysis and distribution using standard pieces and adaptive, battery-aware operation.

### Initialize Device and Environment

Generally, the processing subsystem can initiate initialize device and environment by commanding the power management circuitry to activate independent power domains and by querying subsystem health across the timing microcontroller, the real-time clock chip, the streaming single-board computer, the camera module, the display subsystem, and the environmental sensor module. More specifically, the power management circuitry can apply power to a clock domain battery pack, a streaming domain battery pack, and a display domain battery pack and can verify stable voltage within exemplary tolerances (e.g., within ±3% of nominal) before the processing subsystem enables higher-level services. Additionally, the connectivity subsystem can establish network connectivity by scanning available networks according to a tournament parameters manifest, and the wi-fi module can authenticate with stored credentials and negotiate transport parameters for data transmission. In particular, the camera module can guide mechanical alignment relative to a physical chess board by presenting alignment prompts through the display subsystem, and a user can adjust orientation using the physical push buttons and/or the touch interface until the processing subsystem confirms alignment. Then, the camera module can capture a calibration image, and the streaming single-board computer can detect board boundaries and orientation, adjust focus, exposure, and white balance, and persist calibration values for subsequent move recognition. Furthermore, the security subsystem can validate authenticity and integrity of device firmware by executing a cryptographic signature verification routine on executable code before the processing subsystem enables full operation. Also, the environmental sensor module can measure ambient temperature, humidity, and lighting, and the processing subsystem can compare measured values against predefined thresholds and either prompt the user for corrective actions via the user interface subsystem or enter a safe mode when required. Additionally, the real-time clock chip can synchronize time via a network time protocol through the connectivity subsystem when connectivity exists, and the timing microcontroller can confirm that chess timing services remain active during synchronization. Subsequently, the processing subsystem can declare an initialized and aligned device state when all subsystems report readiness, all power domains remain stable, the camera achieves optical and mechanical alignment, firmware authenticity is confirmed, and environmental conditions reside within specified operational limits; therefore, the initialization sequence can automate setup, reduce operator burden, and ensure reliable capture, timing, and streaming for over-the-board events while mitigating conflicts between precise timekeeping and power-intensive sensing and connectivity.

### Activate Independent Power Domains

Power management circuitry can activate independent power domains by energizing a first power domain dedicated to low-power timing and user interface operations and by energizing a second power domain dedicated to high-power streaming, camera, and display operations. power system can supply each power domain via a separate battery pack, such as a dual-cell parallel variant of 18650 lithium-ion cells or a lithium-polymer slimline variant, with independent charging, protection, and regulation stages configured to provide nominal voltage rails within a tolerance window (e.g., ±5% of nominal voltage). power management circuitry can verify successful activation by sampling state of charge via coulomb counting or open-circuit voltage estimation, by estimating internal resistance via pulse-load measurements within a defined current step range (e.g., 0.1-1.0 C), and by measuring temperature via board-mounted thermistors to validate operation within safe limits (e.g., 0-45 °C for charge and −20-60 °C for discharge). power management circuitry can perform isolation integrity checks by measuring inter-domain impedance across disconnected rails to exceed a threshold (e.g., >1 MΩ) and by monitoring for voltage transients during step-load changes on the streaming domain to maintain cross-domain ripple below a target (e.g., <50 mV peak-to-peak on the timing domain). power system can optionally activate a third power domain for display subsystem elements, such as an OLED panel or an E-Ink panel, with a dedicated display domain battery pack and regulation path that supports fast transient response for OLED drive or ultra-low quiescent consumption for E-Ink refresh intervals. power management circuitry can initialize monitor battery and temperature to continuously track battery and temperature telemetry, can initialize modify operations to conserve power to gate non-critical loads when measured parameters exceed policy thresholds, and can initialize predict remaining runtime to estimate domain-specific runtime for selective load shedding. power management circuitry can support hot-swappable battery cage or tool-less removable cartridge variants by latching domain power through ideal-diode ORing and by debouncing attach events to prevent brownouts on the timing domain, and can leverage a supercapacitor-assisted burst variant to buffer frame-capture surges without perturbing the timing domain. Therefore, power management circuitry and power system can establish an independent power domains energized configuration that preserves timing reliability during power-intensive streaming and display activity, thereby addressing conflicts between precise chess timing and battery life while enabling selective powering based on operational requirements or user configuration.

### Establish Network Connectivity

The connectivity subsystem can establish network connectivity by instructing the wi-fi module to scan for available wireless local area networks according to a configurable dwell time per channel (e.g., 20 ms to 200 ms), and the streaming single-board computer can select a target access point according to priority rules derived from a tournament parameters manifest, such as signal strength thresholds (e.g., greater than −70 dBm), preferred SSID patterns, and historical association success. More specifically, the security subsystem can attempt authentication using stored credentials that correspond to WPA2-PSK or WPA3 personal modes, and the security subsystem can negotiate enterprise authentication flows (e.g., EAP-TTLS or PEAP) when the tournament parameters manifest specifies enterprise parameters; in scenarios involving captive portals, the streaming single-board computer can launch an automated or user-assisted workflow that performs HTTP or HTTPS form submission and/or token exchange through a minimal webview of the user interface subsystem. Then, the streaming single-board computer can obtain network parameters via Dynamic Host Configuration Protocol (DHCP) lease negotiation or, alternatively, the streaming single-board computer can assign a static Internet Protocol address and associated subnet and gateway when the tournament parameters manifest defines static addressing. Additionally, the streaming single-board computer can verify connectivity by performing a Transport Layer Security handshake with a designated cloud endpoint or a local gateway and by measuring latency and packet loss to generate network performance metrics, and the connectivity subsystem can declare a network connectivity established configuration that configures the connectivity subsystem and the wi-fi module for subsequent streaming operations. In one implementation, the streaming single-board computer can enforce a connection timeout (e.g., 15 s to 90 s) that triggers an offline operational mode in which the streaming single-board computer continues to capture raw move event package and captured board image and queues structured game data stream and encoded video stream for deferred upload, and the connectivity subsystem can schedule periodic reassociation attempts according to a backoff policy (e.g., exponential or jittered intervals between 30 s and 10 min). Alternatively or additionally, the connectivity subsystem can adapt the procedure to cellular or Ethernet interfaces when available by invoking a modem abstraction layer or a wired interface manager, respectively, while maintaining identical verification and fallback behaviors. Therefore, the connectivity subsystem and the streaming single-board computer address unreliable venue networking by automating association, authentication, verification, and resilient offline queuing, which enables continuous capture without camera crews and prevents loss of over-the-board game data in constrained tournament environments.

### Calibrate Camera and Board Boundaries

The streaming single-board computer can calibrate camera and board boundaries by commanding the camera module to acquire one or more reference image frames positioned to view a chessboard and by buffering the reference image frames for analysis. The streaming single-board computer can detect geometric boundaries of the chessboard within a captured board image by applying computer vision algorithms that identify four board corners and/or edge lines and by optionally inferring a grid pattern corresponding to chessboard squares. The streaming single-board computer can compute a transformation matrix, such as a homography, that maps pixel coordinates in the captured board image to standardized algebraic chess square coordinates (e.g., a1-h8), and the streaming single-board computer can persist mapping coefficients as board calibration parameters for subsequent move recognition. The streaming single-board computer can adapt to ambient lighting conditions by adjusting camera exposure and white balance through controls of the camera module and by applying image normalization techniques that enhance edge and square detection reliability. The streaming single-board computer can schedule calibration automatically at device startup, and the user interface subsystem can accept a user command to initiate calibration on demand, while the processing subsystem can trigger periodic recalibration during operation to compensate for changes in camera position, lighting, and/or board orientation. The streaming single-board computer can store board calibration parameters in non-volatile memory for real-time move tracking, and the display subsystem can present feedback to a user when a calibration quality metric falls below a predefined threshold to prompt recalibration. The streaming single-board computer can support a variety of board sizes and styles by employing adaptive pattern recognition algorithms that generalize across different chessboard designs, and the streaming single-board computer can parameterize square aspect ratios and border widths to accommodate boards with decorative margins. Therefore, the streaming single-board computer enables accurate localization of chess pieces on standard tournament equipment without proprietary boards and reduces manual setup overhead, which addresses impractical broadcasting logistics and compatibility constraints while improving reliability for automated over-the-board capture.

### Capture and Time Chess Moves

The timing microcontroller can monitor hardware interrupts from the physical push buttons to detect completion of a player move and can assert a move event indicator for downstream consumers in the integrated chess game capture and streaming method. The real-time clock chip can generate a timestamp at the interrupt edge with sub-millisecond granularity (e.g., between 0.1 ms and 5 ms) and can deliver the timestamp to the streaming single-board computer for association with player clock states. The camera module can trigger frame capture on move events and can acquire a captured board image or short video segment at a target resolution (e.g., between 1080 p and 2160 p) immediately after the timing microcontroller signals the move. The streaming single-board computer can apply recognize piece positions via computer vision to the captured board image and can produce a board state map that identifies square occupancy and piece identity with a confidence score (e.g., between 0.5 and 0.999). The streaming single-board computer can combine the timestamp, the player clock states from the timing microcontroller, and the board state map from the camera module processing and can serialize the combined data as a raw move event package for subsequent processing. In one implementation, the streaming single-board computer can validate move legality by comparing successive board state map against encoded chess rules and can drive the user interface subsystem to prompt for confirmation or correction when a discrepancy exceeds a threshold. Additionally, the environmental sensor module can sample temperature and illumination at the move event and can append the readings as auxiliary metadata to the raw move event package. Thus, the coordinated operation of the timing microcontroller, the real-time clock chip, the camera module, and the streaming single-board computer can capture over-the-board moves without specialized boards, can align precise clock states with visual evidence, and can reduce reliance on manual operators, thereby addressing lack of affordable recording, synchronization between timing and imaging, and reliability under mixed workloads.

### Track Player Time

Generally, the timing microcontroller can track player time by incrementing or decrementing a remaining time counter for an active player according to pulses from a real-time clock chip and according to interrupts generated by a user interface subsystem when a player presses physical push buttons and/or interacts with a touch interface. More specifically, the timing microcontroller can interface with the real-time clock chip via a serial bus (e.g., I2C) and can sample a clock tick at a target frequency (e.g., 1 Hz with an exemplary accuracy between ±1 ppm and ±5 ppm over 0-40 °C) to update the remaining time, while the timing microcontroller can handle button edge events with a debouncing interval (e.g., between 3 ms and 20 ms) to switch the active player and to issue a move event indicator as an output to downstream components. In particular, the timing microcontroller can operate within a dedicated clock domain powered by a clock domain battery pack and regulated by power management circuitry, and the timing microcontroller can maintain electrical isolation from a streaming domain battery pack, a camera module, and a display subsystem to avoid load-induced jitter and latency; the real-time clock chip can continue timekeeping from a coin cell source during main battery replacement to prevent drift. Additionally, the timing microcontroller can implement multiple chess time control modes, including increment, delay, and Bronstein, by applying a parameterized per-move adjustment (e.g., between 0.1 s and 60 s) to the remaining time upon reception of a valid move press, and the timing microcontroller can log time usage samples at periodic intervals (e.g., between 0.5 s and 5 s) to create a per-player timing trace for later analysis. Alternatively, the timing microcontroller can monitor for timing anomalies by comparing tick counts against expected RTC periods and by flagging missed presses or double presses beyond a threshold rate (e.g., between 2 and 10 events per second) and can set an anomaly status bit that accompanies the move event indicator. In one implementation, the timing microcontroller can communicate consolidated timing data to a streaming single-board computer via a low-bandwidth link (e.g., UART at between 9.6 kbps and 115.2 kbps) for display, streaming, and analysis while keeping all timing logic and updates local to the dedicated clock domain, and the real-time clock chip can include a device such as a DS3231 while the timing microcontroller can include a device such as a SAMD21G18A or equivalents. Thus, the timing microcontroller and the real-time clock chip address conflicts between precise chess timing and power-intensive capture and streaming by maintaining accuracy independent of voltage transients in other domains, by generating the move event indicator to synchronize capture without adding processing latency, and by preserving continuous timekeeping during battery service to support uninterrupted over-the-board broadcasting.

### Recognize Piece Positions Via Computer Vision

Generally, the streaming single-board computer can execute recognize piece positions via computer vision and can process a captured board image from the camera module to generate a board state map that specifies occupancy and piece type for each square. More specifically, the streaming single-board computer can apply geometric correction according to board calibration parameters and can compute a homography and/or a perspective transformation to align the captured board image to a standard coordinate system with an 8×8 grid. In particular, the streaming single-board computer can segment the aligned image into individual squares and can extract visual features from each segment at a selectable resolution to support various camera resolutions, board sizes, and piece styles. Additionally, the streaming single-board computer can classify each segment with a machine learning classifier, such as a convolutional neural network or another trained model, and can assign a piece type and a color based on the extracted features. Also, the streaming single-board computer can optionally augment classification by performing background subtraction, edge detection, and/or template matching to stabilize detection under variable lighting and diverse chess set designs. Then, the streaming single-board computer can validate the detected arrangement by cross-referencing legal chess constraints and by rejecting configurations that violate move legality or piece count expectations. Subsequently, the streaming single-board computer can operate the recognition either continuously or at discrete intervals that the move event indicator triggers to balance latency and resource consumption. Thus, the streaming single-board computer enables automatic capture of standard over-the-board games without modified equipment, which addresses the lack of practical recording for physical events and reduces reliance on specialized crews while producing reliable, real-time data for downstream analysis and streaming.

### Annotate Data for Stream Overlays

The streaming single-board computer can annotate data for stream overlays by transforming the structured game data stream into an overlay metadata snippet that a compatible overlay engine can composite with an outgoing video stream in real time or near-real time. In one implementation, the streaming single-board computer can generate structured data representations, such as JSON and/or XML, that encode timing information (e.g., remaining time per player and increment/delay values), move lists (e.g., algebraic notation with move numbers and timestamps), and evaluation metrics (e.g., engine-derived scores and probability bars) for synchronized rendering. More specifically, the streaming single-board computer can update the overlay metadata snippet according to an event-driven schedule after each move, time control change, and/or evaluation update, and the streaming single-board computer can fall back to a periodic update schedule at an exemplary interval between 100 ms and 2 s to maintain continuity. Additionally, the streaming single-board computer can enrich the overlay metadata snippet with contextual metadata, such as player names, tournament round identifiers, and board orientation, to support accurate placement and styling of overlay elements. Alternatively, the streaming single-board computer can offload annotation to a remote server when available compute or power budgets warrant, and the streaming single-board computer can negotiate schema variants and update frequency according to platform requirements, available bandwidth, and user preferences. Thus, the streaming single-board computer can deliver automated and synchronized overlay metadata that reduces manual broadcast labor, improves viewer comprehension, and enables downstream analytics and monetization workflows without imposing incompatible hardware at the board.

### Stream Video and Metadata

Generally, the streaming single-board computer can execute stream video and metadata to combine a captured board image sequence and an overlay metadata snippet with a structured game data stream into one or more encoded video stream objects according to an active streaming parameter set. More specifically, the streaming single-board computer can execute encode video stream to compress video frames and optional audio while the streaming single-board computer can serialize the structured game data stream and AI commentary and highlight assets as timed metadata for synchronized presentation. Additionally, the streaming single-board computer can execute transmit stream to cloud service through the connectivity subsystem and the wi-fi module to deliver a live annotated video stream to one or more ingestion endpoints while the connectivity subsystem can produce network performance metrics for real-time feedback. Then, the streaming single-board computer can execute adjust stream parameters based on conditions to modify resolution, frame rate, and compression ratio of the active streaming parameter set using the network performance metrics and battery and temperature telemetry to target an end-to-end latency below approximately 0.3 to 1.0 seconds. In one implementation, the streaming single-board computer can select a multiplexing mode that embeds the overlay metadata snippet within the encoded video stream or the streaming single-board computer can maintain parallel video and metadata streams for downstream platforms that require separation. In another implementation, the connectivity subsystem can apply buffering and selective retransmission policies to preserve continuity of the live annotated video stream under variable bandwidth while the streaming single-board computer can throttle nonessential overlay metadata snippet updates to conserve power. Thus, the streaming single-board computer and the connectivity subsystem address live over-the-board broadcast availability without camera crews, maintain reliable low-latency delivery under power and network constraints, and enable synchronized AI-enhanced overlays that support analysis and monetization use cases.

### Encode Video Stream

Generally, the streaming single-board computer can encode video stream by compressing a captured board image sequence from the camera module into an encoded video stream that suits real-time transmission and storage. More specifically, the streaming single-board computer can execute encode video stream according to an active streaming parameter set that selects a video compression standard (e.g., H.264/AVC and/or HEVC/H.265) and configures profile, level, and GOP structure for chess game capture. In particular, the streaming single-board computer can apply chess-specific motion estimation presets that increase intra refresh frequency over a board region, adjust quantization parameters to preserve piece edges, and suppress blocking and ringing artifacts that could hinder recognize piece positions via computer vision. Additionally, the streaming single-board computer can multiplex an overlay metadata snippet and a structured game data stream into the encoded video stream by inserting timestamps synchronized to a real-time clock chip, move annotations derived from update internal game state database, and player identification tags for downstream analysis. Then, the streaming single-board computer can adapt bitrate, resolution, and frame rate during encode video stream based on network performance metrics, battery and temperature telemetry, and/or a detected game phase to balance visual fidelity and latency. Alternatively, the streaming single-board computer can select output containerization compatible with RTSP and/or RTMP so that transmit stream to cloud service can consume the encoded video stream without re-encoding. In one implementation, the streaming single-board computer can invoke a hardware-accelerated encoder block to reduce end-to-end encoding latency (e.g., sub-150 ms) and to lower compute power relative to software encoding across a range of bitrates (e.g., 500 kb/s to 6 Mb/s). Further, the streaming single-board computer can align keyframe intervals with trigger frame capture on move events so that create highlight clips can later extract segment-accurate snippets without quality loss. Thus, the streaming single-board computer addresses the technical challenges of low-cost broadcast and reliable over-the-board capture by preserving board clarity for move recognition, minimizing power draw that conflicts with precise timing, and enabling real-time distribution that supports analysis and monetization.

### Transmit Stream to Cloud Service

Generally, the connectivity subsystem can transmit stream to cloud service by establishing a session with one or more remote streaming endpoints and by exchanging a handshake that authenticates with pre-stored credentials and/or session tokens; in one implementation, the connectivity subsystem can select an endpoint protocol such as RTMP or RTSP according to an active streaming parameter set and can commence packetized data transfer after the handshake. More specifically, the streaming single-board computer can supply an encoded video stream and overlay metadata snippet to the connectivity subsystem, and the connectivity subsystem can packetize the encoded video stream and the overlay metadata snippet according to the selected protocol while the connectivity subsystem concurrently verifies acknowledgment messages and measures round-trip latency to produce network performance metrics. Additionally, the connectivity subsystem can transmit the packetized data to multiple endpoints in parallel, and the connectivity subsystem can perform independent handshakes and independent integrity monitoring for each endpoint to maintain a live annotated video stream toward each destination. In one implementation, the security subsystem can encrypt outbound packets according to endpoint requirements prior to transmission, and the connectivity subsystem can buffer a sliding window of outgoing data to bridge transient network interruptions without visible stream discontinuities. Then, the connectivity subsystem can log transmission statistics such as packet loss rates, latency measurements, and endpoint response codes for later analysis, and the connectivity subsystem can furnish the network performance metrics to the streaming single-board computer so that the streaming single-board computer can adjust stream parameters based on conditions in a subsequent step. Thus, the connectivity subsystem and the streaming single-board computer can cooperatively deliver the live annotated video stream to cloud services with authenticated, monitored, and optionally encrypted sessions, which addresses the lack of practical live broadcasting for over-the-board events by automating reliable distribution without specialized crews and by enabling scalable monetization endpoints.

### Adjust Stream Parameters Based on Conditions

Generally, the streaming single-board computer can adjust stream parameters based on conditions by generating an active streaming parameter set that configures encoder resolution, frame rate, target bitrate, and encoder quantization to balance power usage, network reliability, and viewer experience. More specifically, the streaming single-board computer can sample battery and temperature telemetry from power management circuitry at a periodic interval (e.g., between 1 and 10 seconds) and can estimate remaining runtime using a predicted runtime estimate to decide when to reduce video resolution (e.g., from 1920×1080 to 1280×720), lower frame rate (e.g., from 30 fps to 15-20 fps), and increase H.264 constant rate factor (e.g., CRF raised by 4-8 levels) to decrease average power draw. Additionally, the streaming single-board computer can receive network performance metrics from the connectivity subsystem, can detect bandwidth drops or packet loss spikes (e.g., throughput below 1-2 Mbps or loss above 2-5%), and can reduce target bitrate, frame rate, and/or spatial resolution to maintain continuous delivery without excessive buffering or dropped frames. In particular, the streaming single-board computer can compute a game criticality score using the structured game data stream and position evaluation metrics by combining time remaining on each clock, evaluation volatility over recent plies, and tournament phase indicators, and can temporarily raise streaming quality parameters when the score exceeds a configurable threshold while scheduling a reversion to baseline settings after a decay period. Also, the streaming single-board computer can apply a rules-based policy table for immediate guardrail actions and can invoke a machine learning model trained on historical network, battery, and engagement data to predict near-term conditions and preemptively set parameters. Then, the streaming single-board computer can reconfigure the encoder using encoder reconfiguration APIs without restarting the pipeline and can switch adaptive bitrate profiles using RTMP with dynamic profile signaling and/or HLS or DASH manifest updates to avoid visible interruptions. Subsequently, the streaming single-board computer can update the active streaming parameter set and can signal the connectivity subsystem to apply the new bitrate and buffer targets while keeping timestamps aligned with the structured game data stream and overlay metadata snippet. Alternatively, the streaming single-board computer can rate-limit changes by enforcing a minimum interval between adjustments (e.g., 5-30 seconds) and can apply hysteresis thresholds to prevent oscillation under marginal conditions. Further, the streaming single-board computer can log each adjustment decision with the associated condition vector and outcome metrics to enable offline tuning and on-device model refinement. Thus, the streaming single-board computer addresses conflicts between battery life, transmission reliability, and viewer experience by adapting quality in real time, which supports unattended tournament operation and reduces reliance on specialized crews while preserving continuous coverage needed for downstream analysis and monetization.

### Generate AI Commentary and Analysis

The streaming single-board computer can execute generate AI commentary and analysis to transform a structured game data stream into AI commentary and highlight assets in temporal alignment with a live annotated video stream. The streaming single-board computer can evaluate position with chess engine to produce position evaluation metrics that characterize score deltas, principal variations, and tactic flags at each move or at defined intervals. The streaming single-board computer can generate natural language commentary to synthesize a natural-language commentary block from the position evaluation metrics, where a natural language generation model can modulate technical depth and language according to viewer preferences received via the user interface subsystem and/or tournament parameters manifest. The streaming single-board computer can create highlight clips to assemble a highlight clip package by selecting segments that exhibit rapid position evaluation metric changes, large time usage swings derived from the structured game data stream, and move quality annotations supplied by evaluate position with chess engine and generate natural language commentary. The connectivity subsystem can route subsets of generate AI commentary and analysis to a remote server for model inference when available bandwidth permits and can revert to on-device execution to maintain continuity under constrained network conditions. The processing subsystem can adapt commentary style to audience proficiency by mapping interaction signals from the user interface subsystem and engagement metrics from the live annotated video stream to NLG parameters that control jargon level, explanation length, and pedagogical cues. The streaming single-board computer can packetize the AI commentary and highlight assets with identifiers that reference move indices of the structured game data stream so that stream video and metadata can synchronize captions, graphics, and replay triggers during distribution and so that store and manage tournament data can persist the same assets for later retrieval and monetization. Therefore, the generate AI commentary and analysis step can address the absence of integrated real-time commentary for physical events, can reduce reliance on manual broadcast crews by automating expert-like narration, and can enable monetization through multilingual overlays and on-demand highlight packages.

### Evaluate Position With Chess Engine

Generally, the streaming single-board computer can execute evaluate position with chess engine to analyze a current chess position represented within the structured game data stream as a FEN description and to produce position evaluation metrics for downstream consumers. More specifically, the streaming single-board computer can provide the structured game data stream and a board state map to a neural-network-based engine configured to compute centipawn scores, best-move recommendations, and principal variation lines, and the streaming single-board computer can validate consistency between the board state map and the FEN description before computation to reduce propagation of recognition errors. In particular, the streaming single-board computer can select an engine backend and evaluation parameters according to an active streaming parameter set and a tournament parameters manifest, where the streaming single-board computer can set search depth within an exemplary range of 6-24 plies, time allocation within an exemplary range of 50-2000 milliseconds per position, and number of principal variations within an exemplary range of 1-5 lines. Additionally, the streaming single-board computer can execute the engine locally on available cores of the processing subsystem and/or can offload the structured game data stream to a remote service via the connectivity subsystem and the wi-fi module when thermal or power budgets favor remote inference. Then, the streaming single-board computer can schedule evaluate position with chess engine after each move event, at periodic intervals (e.g., between 0.5 and 5.0 seconds), and/or upon a user request received through the user interface subsystem to balance latency and compute cost. Subsequently, the streaming single-board computer can generate the position evaluation metrics and can embed identifiers in the structured game data stream to preserve alignment with a natural-language commentary block and a highlight clip package produced later. Further, the streaming single-board computer can forward the position evaluation metrics to the generate natural language commentary step and to the create highlight clips step to enable narrative explanations and tactic surfacing with engine-backed confidence values. Thus, the generate AI commentary and analysis step can rely on the position evaluation metrics to deliver timely and reliable over-the-board analysis, which addresses the absence of integrated real-time AI commentary for physical chess events.

### Generate Natural Language Commentary

Generally, the streaming single-board computer can generate natural language commentary by transforming position evaluation metrics and structured game data stream into a natural-language commentary block suitable for real-time broadcast or post-game review. More specifically, the streaming single-board computer can parse position evaluation metrics that include engine scores, principal variation lines, and move likelihoods and can render the natural-language commentary block according to audience-appropriate terminology and tone. In one implementation, the streaming single-board computer can employ rule-based templates, machine learning models, and/or neural network-based language models to produce the natural-language commentary block that explains threats, tactics, strategic plans, and blunders. Additionally, the streaming single-board computer can enrich the natural-language commentary block with contextual factors derived from the structured game data stream such as time pressure, tournament stage, and/or player history. In particular, the streaming single-board computer can monitor the structured game data stream for evaluation swings and critical moves and can trigger incremental updates to the natural-language commentary block when the streaming single-board computer detects significant changes. Alternatively, the streaming single-board computer can adapt commentary depth and style based on viewer preferences and detected player skill level and can output the natural-language commentary block in multiple languages for accessibility. Then, the streaming single-board computer can package the natural-language commentary block together with a highlight clip package to form AI commentary and highlight assets for downstream overlay and archival use. Also, the streaming single-board computer can deliver the natural-language commentary block as on-screen text and/or synthesized audio that the streaming single-board computer can embed into a live annotated video stream. In one implementation, the streaming single-board computer can annotate time management decisions, tactical alerts, and educational explanations as overlay metadata snippet that the streaming single-board computer aligns with corresponding frames and moves. Additionally or alternatively, the streaming single-board computer can rate-limit or batch commentary updates according to an active streaming parameter set to balance latency and bandwidth during live production. Thus, the streaming single-board computer addresses the lack of integrated real-time AI commentary for physical chess events by producing the natural-language commentary block and the AI commentary and highlight assets directly from position evaluation metrics and the structured game data stream, which enables automated, scalable broadcasting without dedicated human commentators.

### Create Highlight Clips

The streaming single-board computer can execute create highlight clips to automatically identify and extract video segments that correspond to significant sequences within a live annotated video stream and/or within cloud-synchronized game assets. More specifically, the streaming single-board computer can evaluate position evaluation metrics and correlate abrupt changes with a structured game data stream and a move event indicator to select candidate highlight intervals that correspond to tactics, blunders, or forced mates. Additionally, the timing microcontroller can provide move event indicator values and remaining time data that the streaming single-board computer ingests to detect time pressure events that warrant highlight creation. In one implementation, the user interface subsystem can accept user-defined markers via the touch interface and/or the physical push buttons that the streaming single-board computer incorporates as override cues for clip start and clip end boundaries. In particular, the real-time clock chip can supply monotonically increasing timestamps that the streaming single-board computer aligns with video frames and with the structured game data stream to synchronize a natural-language commentary block to the precise timing of chess moves. Additionally, the streaming single-board computer can render overlay metadata snippet content such as move arrows, evaluation bars, player names, and event identifiers onto each selected segment to produce a highlight clip package. Then, the streaming single-board computer can export the highlight clip package in standard video formats (e.g., MP4 or MOV within an exemplary range of 480 p to 1080 p) with metadata tags that include hashtags, player names, and event identifiers, and the streaming single-board computer can upload the AI commentary and highlight assets to designated social-media platforms and/or to a cloud-based content management system. Alternatively, the streaming single-board computer can generate the highlight clip package in real time during stream video and metadata to enable near-instant distribution, or the streaming single-board computer can generate the highlight clip package post-game using the cloud-synchronized game assets for batch processing. In one embodiment, a tournament operator may review the highlight clip package on the display subsystem and may adjust clip boundaries or overlay scopes via the touch interface before the streaming single-board computer publishes the AI commentary and highlight assets. Therefore, the streaming single-board computer can automate the generation and distribution of engaging highlight content, which addresses the lack of integrated real-time commentary tools and enables monetization and scalable broadcasting without specialized crews.

### Store and Manage Tournament Data

Generally, the streaming single-board computer can execute store and manage tournament data by transmitting a structured game data stream, a live annotated video stream, and AI commentary and highlight assets to a cloud service and by persisting the resulting cloud-synchronized game assets under tournament-scoped identifiers (e.g., event, round, board, player, and timestamp ranges). More specifically, the store video and game data in cloud step can index move sequences, timing information, and encoded media with partition keys and secondary indices that enable low-latency retrieval for per-board playback and round-level aggregation, and the store video and game data in cloud step can retain archival objects for a configurable retention window (e.g., between 6 and 120 months). Additionally, the perform automated pairing and scheduling step can generate a next-round pairings schedule by applying pairing logic that consumes player ratings, previous results, and tournament parameters manifest constraints, and the perform automated pairing and scheduling step can publish schedule updates to user interface subsystem displays and to external endpoints via the connectivity subsystem. Furthermore, the execute anti-cheating analysis step can analyze gameplay patterns and timing features across boards by correlating the structured game data stream with position evaluation metrics to produce a cheating analysis report, and the execute anti-cheating analysis step can flag outlier segments for director review using thresholds that the tournament parameters manifest defines. In one implementation, the security subsystem can enforce data security and privacy controls by encrypting in-flight transfers and by mediating role-based access to pairing, results, and reports, and the security subsystem can log administrative actions for audit. In another implementation, the connectivity subsystem can synchronize state changes in near real time across director consoles and participant portals by subscribing to change feeds of the cloud-synchronized game assets, and the connectivity subsystem can integrate with federation or third-party analytics APIs for ratings uplifts and bulletin export. Thus, the store and manage tournament data step can consolidate capture outputs into durable, queryable assets while automating pairing, oversight, and distribution, which addresses manual tournament management workflows and enables scalable operations across many concurrent boards.

### Store Video and Game Data in Cloud

The streaming single-board computer can store video and game data in cloud by packaging an encoded video stream and a structured game data stream with optional AI commentary and highlight assets into an upload batch and by transmitting the upload batch to a cloud object storage endpoint via the connectivity subsystem using secure protocols (e.g., HTTPS and/or SFTP). More specifically, the streaming single-board computer can associate each uploaded asset of the upload batch with metadata tags that can include event identifiers, round numbers, board numbers, player identifiers, and timestamp information to enable subsequent retrieval and indexing of cloud-synchronized game assets. In particular, the security subsystem can encrypt compressed video files and JSON and/or PGN records prior to transmission and can compute checksums that the security subsystem can later validate against acknowledgments received from a remote cloud service. Additionally, the connectivity subsystem can implement resumable and multipart uploads that can recover from network interruptions and can optionally write each asset to multiple geographically distributed storage locations according to a configured redundancy policy. Then, the streaming single-board computer can trigger upload operations automatically when the structured game data stream signals game completion, at scheduled intervals derived from a tournament parameters manifest, or in response to user commands that the user interface subsystem can capture from physical push buttons and/or a touch interface. Alternatively, the streaming single-board computer can select a storage provider by loading configurable storage endpoints and access credentials from the processing subsystem and can verify successful persistence by requesting confirmations that the security subsystem can cross-check with checksum values. Subsequently, the store video and game data in cloud step can output cloud-synchronized game assets that the streaming single-board computer can reference for downstream operations, such as perform automated pairing and scheduling and/or execute anti-cheating analysis. Thus, the streaming single-board computer and the connectivity subsystem address loss of over-the-board records and manual post-event handling by persisting authenticated, indexed, and redundant video and game data that the system can later monetize and analyze without relying on manual data entry or ad hoc storage.

### Perform Automated Pairing and Scheduling

Generally, the streaming single-board computer can perform automated pairing and scheduling by ingesting cloud-synchronized game assets and structured game data stream records to compute a next-round pairings schedule according to configurable pairing algorithms. More specifically, the streaming single-board computer can select a Swiss-system, round-robin, or accelerated-variant policy and compute pairings while the timing microcontroller supplies per-player remaining time and the processing subsystem derives ongoing game durations and result confirmations from the structured game data stream. In particular, the streaming single-board computer can execute predictive analytics that estimate game completion windows (e.g., within 2 to 15 minutes) based on historical player pacing rates (e.g., 0.3 to 2.0 moves per minute), current board state complexity extracted from recognize piece positions via computer vision, and remaining increment or delay parameters captured by track player time. Additionally, the streaming single-board computer can adjust round start times and table assignments to minimize idle intervals by solving a resource allocation objective that penalizes empty-table minutes and repeated pairings, and the streaming single-board computer can resolve color balance and opponent repetition constraints by querying the comprehensive game record dataset maintained by store and manage tournament data. Then, the connectivity subsystem can synchronize the next-round pairings schedule to all connected devices and the user interface subsystem can render digital pairing sheets on the display subsystem and/or dispatch notifications, while the security subsystem can sign pairing payloads to authenticate organizer updates. Alternatively, the streaming single-board computer can apply adaptive round scheduling that advances ready sections of the field when predicted completion windows of remaining games exceed a configurable threshold (e.g., greater than 10 minutes), and the streaming single-board computer can reflow table maps when environmental sensor module data indicates venue-area constraints. Also, the streaming single-board computer can generate automated conflict resolution suggestions when the pairing computation detects repeated pairings or color imbalances, and the streaming single-board computer can update the next-round pairings schedule in real time in response to early finishes or delays reported by the structured game data stream. Thus, the streaming single-board computer and the associated subsystems can eliminate manual tournament pairing and scheduling effort by producing synchronized, constraint-compliant pairings and start times that adapt to live conditions, which addresses labor-intensive and error-prone tournament management workflows.

### Execute Anti-Cheating Analysis

The streaming single-board computer can execute anti-cheating analysis by ingesting cloud-synchronized game assets and by correlating a structured game data stream with a live annotated video stream to derive per-move features that include engine match rates, centipawn loss values, and board state transitions over sliding windows of 5 to 30 plies; more specifically, the streaming single-board computer can evaluate move sequences against position evaluation metrics to compute a move quality distribution and to compare that distribution against statistical profiles derived from known human and engine play. The timing microcontroller can contribute timing signatures by attaching per-move elapsed times and by computing intra-move variance and burst-response counts to reveal abnormally consistent move durations or unusually fast decisions in positions that the evaluate position with chess engine step scores as high-complexity states. The environmental sensor module can augment player interaction records by capturing ambient noise levels and by recording proximity or motion events near the diclano chess clock device to enable cross-referencing of suspicious temporal correlations between environmental spikes and high-accuracy moves. The camera module can supply frame-derived interaction cues by detecting hand presence intervals and by aligning captured board image with board calibration parameters to verify that recognized move start times match physical interactions. The security subsystem can apply threshold logic by comparing engine agreement percentages (e.g., 70% to 95% over configurable windows), time-normalized z-scores (e.g., |z| greater than 2 to 4), and probability-of-sequence metrics (e.g., p-values less than 0.01 to 0.05) to flag games or individual moves that exceed configurable anomaly boundaries. The streaming single-board computer can perform real-time monitoring during live games by streaming partial statistics to the store and manage tournament data step and can perform post-game batch analysis by recomputing models on finalized cloud-synchronized game assets to reduce false positives introduced by provisional recognitions. The connectivity subsystem can integrate cloud-based anti-cheating databases by querying cross-event identifiers and by updating player-specific baselines so that recurring engine-like patterns across events trigger elevated review states. The user interface subsystem can enable authorized personnel to initiate manual reviews by selecting flagged segments and by requesting expanded explanations that include annotated move lists, timing plots, and engine depth summaries. The streaming single-board computer can generate a cheating analysis report that enumerates flagged moves, lists statistical justifications, and recommends actions for tournament director review, and the store and manage tournament data step can archive the cheating analysis report with the comprehensive game record dataset for auditability. Thus, the streaming single-board computer and the security subsystem automate anomaly detection and reporting to reduce labor-intensive anti-cheating workflows in tournament management while preserving repeatable, parameterized criteria for director decisions.

### Optimize Power and Resources

Generally, the power system can execute optimize power and resources to coordinate energy usage across a clock domain battery pack, a streaming domain battery pack, and a display domain battery pack while maintaining functional performance of a diclano chess clock device. More specifically, the power management circuitry can monitor battery and temperature and produce battery and temperature telemetry at an exemplary sampling cadence (e.g., between 0.5 Hz and 2 Hz) to track pack voltages, pack currents, regulator temperatures, and board-level thermal gradients. In particular, the power management circuitry can predict remaining runtime and output a predicted runtime estimate by fusing the battery and temperature telemetry with historical consumption profiles and scheduled activities derived from a tournament parameters manifest. Additionally, the processing subsystem can dynamically allocate workload by assigning latency-sensitive timing to a timing microcontroller and by shifting compute-intensive streaming and analysis to a streaming single-board computer according to available battery capacity and thermal headroom so that excessive drain on a single domain does not occur. Further, the power management circuitry can modify operations to conserve power and enter a power-saving operational mode by reducing video encoder bitrate and frame rate on the streaming single-board computer, by reducing evaluation cadence for generate AI commentary and analysis, and by dimming a display subsystem to a lower brightness setpoint. Also, the connectivity subsystem can reduce Wi-Fi module transmit power and duty cycle, and the sensor subsystem can idle a camera module between move events based on a move event indicator to minimize nonessential activity. Optionally, the power management circuitry can suspend non-timing-critical streaming, can gate peripherals of a user interface subsystem, and can request user intervention for hot-swap of the streaming domain battery pack when the predicted runtime estimate drops below a configurable reserve (e.g., between 10% and 25%). In one implementation, the power-optimized operating mode can configure the streaming single-board computer and the display subsystem while the timing microcontroller continues to track player time from the clock domain battery pack to preserve clock accuracy under all conservation states. Thus, the power system and the power management circuitry address conflicts between continuous timing reliability and power-intensive streaming and analysis by prioritizing the timing microcontroller domain, by throttling or deferring lower-priority tasks, and by extending untethered runtime for tournament-length operation.

### Monitor Battery and Temperature

power management circuitry can execute monitor battery and temperature and can periodically acquire measurements of battery state-of-charge, battery voltage, and component temperature from the clock domain battery pack, the streaming domain battery pack, the display domain battery pack, the timing microcontroller, the streaming single-board computer, and the power system. sensor subsystem can provide the measurements via analog-to-digital converters and/or via digital sensor interfaces so that power management circuitry can obtain real-time values for charge level (e.g., expressed as a percentage or an absolute capacity), instantaneous voltage (e.g., measured in volts), and thermal readings (e.g., measured in degrees Celsius) from critical components. streaming single-board computer can dynamically adjust a sampling interval according to an operational mode, such as an active streaming mode or an idle timing mode, and processing subsystem can bound the interval within an exemplary range (e.g., between 100 ms and 10 s) to balance resolution and energy cost. power management circuitry can generate battery and temperature telemetry and can transmit the battery and temperature telemetry to a central policy engine that can reside on the streaming single-board computer and/or on a cloud-based platform for device fleet coordination. The central policy engine can use the battery and temperature telemetry to adjust an active streaming parameter set on the streaming single-board computer, to adjust brightness on the display subsystem, and to initiate thermal throttling on the processing subsystem when a thermal threshold (e.g., between 70 and 85 degrees Celsius) is exceeded. processing subsystem can filter the measurements via averaging and/or low-pass techniques to reduce noise, and storage and logging functions of the streaming single-board computer can persist historical battery and temperature telemetry for predictive maintenance and for alert generation based on configurable thresholds. Thus, power management circuitry and the central policy engine can maintain timing reliability of the timing microcontroller while conserving energy of the independent power domains, thereby addressing conflicts between power-intensive streaming operations and precise chess timing in tournament environments.

### Modify Operations to Conserve Power

As shown in FIG. 1, power management circuitry can execute modify operations to conserve power by analyzing battery and temperature telemetry and predicted runtime estimate and by selecting power-conserving actions according to a policy derived from a tournament parameters manifest. power management circuitry can lower an operating frequency and/or voltage of the streaming single-board computer according to a dynamic voltage and frequency scaling schedule that targets processor utilization bands (e.g., 20-60% CPU load) to reduce computation energy while maintaining stream pipeline deadlines. display subsystem can reduce a luminance setpoint and can shorten a backlight duty cycle or an OLED drive current across LCD panel and/or OLED panel while e-ink panel updates can be deferred to move events to minimize display energy without degrading legibility. camera module can decrease a capture resolution and/or a frame rate within an exemplary range (e.g., from 1080 p30 to 720 p10) while streaming single-board computer can adjust an encoder bitrate and a GOP structure to reduce processing cycles and memory bandwidth. connectivity subsystem can lower a transmit power and/or can shift a modulation and coding scheme of the wi-fi module in response to network performance metrics while streaming single-board computer can coalesce uploads to reduce radio on-time. sensor subsystem can park environmental sensor module into an intermittent sampling mode and user interface subsystem can gate illumination and haptic features of physical push buttons and/or touch interface to cut peripheral draw. processing subsystem can suspend non-time-critical background processes and can defer store and manage tournament data tasks so that cloud-synchronized game assets generation proceeds in larger, less frequent batches. streaming single-board computer can throttle evaluate position with chess engine depth and can reduce generate AI commentary and analysis frequency to maintain qualitative outputs with fewer GPU and CPU cycles. power management circuitry can prioritize timing microcontroller by maintaining clock domain battery pack headroom and by isolating power-saving actions to the streaming domain battery pack and display domain battery pack so that track player time continues with deterministic latency. power management circuitry can select a periodic evaluation cadence (e.g., every 1-30 seconds) and/or an event-driven trigger when battery and temperature telemetry indicates a voltage sag rate above a threshold or when predicted runtime estimate falls short of a remaining round duration. user interface subsystem can present user-configurable profiles and can accept a manual override input that power management circuitry can honor within bounds that preserve a power-saving operational mode safety margin. power management circuitry can apply the foregoing adjustments to result in a power-saving operational mode that configures processing subsystem, display subsystem, and power management circuitry while streaming single-board computer, camera module, and connectivity subsystem continue to produce a live annotated video stream with reduced resource demand; therefore, power management circuitry addresses conflicts between battery life and timing reliability by conserving energy in non-essential pathways while timing microcontroller maintains precise chess timing.

### Predict Remaining Runtime

Generally, power management circuitry can execute the predict remaining runtime step by running a predictive algorithm that generates a predicted runtime estimate for the diclano chess clock device. More specifically, power management circuitry can collect battery and temperature telemetry together with measured current draw, device temperature, and active subsystem states from the processing subsystem and the sensor subsystem to assemble features for the algorithm. In one implementation, power management circuitry can reference historical battery discharge profiles stored by the processing subsystem locally and/or by the connectivity subsystem in cloud storage to align present workload and environmental conditions with prior usage patterns. In another implementation, power management circuitry can apply a supervised learning model, such as regression analysis and/or a neural network, trained on prior device usage data to forecast a remaining time value in hours and/or minutes. Additionally, power management circuitry can update the predicted runtime estimate continuously or at defined intervals and can account for dynamic power changes caused by the camera module, the wi-fi module, and the display subsystem. Alternatively, streaming single-board computer can offload computation for the predict remaining runtime step to a cloud-based analytics platform when the connectivity subsystem maintains network connectivity established. Also, user interface subsystem can present the predicted runtime estimate to a user, and streaming single-board computer can log the predicted runtime estimate within the store and manage tournament data step for later analysis. Further, power management circuitry can trigger the modify operations to conserve power step when the predicted runtime estimate falls below a configurable threshold to adjust subsystem behavior. In one embodiment, power management circuitry can incorporate planned tournament duration and/or expected device usage patterns from the tournament parameters manifest to refine the forecast accuracy. Therefore, power management circuitry can mitigate conflicts between power-intensive streaming functions and timing reliability by enabling proactive adjustments that preserve continuous streaming and accurate track player time operation under variable conditions.

We claim:

1. A diclano chess clock device comprising:
a portable enclosure;
a power system comprising:
a clock domain battery pack configured to supply electrical power exclusively to a timing microcontroller and a real-time clock chip; and
a streaming domain battery pack electrically isolated from the clock domain battery pack and configured to supply electrical power to a streaming single-board computer, a camera module, a display subsystem, and a Wi-Fi module;
physical push buttons wired directly to the timing microcontroller;
a unidirectional logic-level data link coupling the timing microcontroller to the streaming single-board computer and configured to convey consolidated timing and button-state information; and
a processing subsystem comprising the timing microcontroller and the streaming single-board computer, wherein timing functions executed by the timing microcontroller remain operable regardless of load fluctuations of components powered by the streaming domain battery pack.

2. The diclano chess clock device of claim 1, further comprising:
a display domain battery pack isolated from both the clock domain battery pack and the streaming domain battery pack and dedicated to the display subsystem.

3. The diclano chess clock device of claim 1, further comprising:
power management circuitry configured to monitor charge, voltage, and temperature of each battery pack and to selectively shut down a streaming domain comprising the streaming single-board computer, the camera module, the display subsystem, and the Wi-Fi module without interrupting timing functions executed by the timing microcontroller.

4. The diclano chess clock device of claim 1, further comprising:
a hot-swappable battery cage configured to permit replacement of any battery pack of the power system without interrupting timing functions executed by the timing microcontroller or streaming operations executed by the streaming single-board computer.

5. The diclano chess clock device of claim 1, further comprising:
a hybrid dual-display configuration comprising an e-ink panel configured to present persistent timing digits and an OLED panel configured to present graphics, wherein the display subsystem is configured to drive the e-ink panel and the OLED panel concurrently.

6. The diclano chess clock device of claim 1, further comprising:
a security subsystem comprising enclosure-breach sensors and firmware-integrity verification logic, the security subsystem configured to generate tamper events and to store the tamper events in non-volatile memory.

7. The diclano chess clock device of claim 1, further comprising:
a sensor subsystem including the camera module and an environmental sensor module, wherein the environmental sensor module is configured to deliver ambient light and temperature telemetry to the streaming single-board computer.

8. The diclano chess clock device of claim 1, further comprising:
a capacitive touch interface integrated with the display subsystem and coupled to the streaming single-board computer for menu navigation and configuration.

9. An integrated chess game capture and streaming method comprising:
activating independent power domains of the diclano chess clock device of claim 1 by energizing a clock domain including the timing microcontroller and the real-time clock chip and a streaming domain including the streaming single-board computer, the camera module, the display subsystem, and the Wi-Fi module;
establishing network connectivity and synchronizing system time;
tracking player time with the timing microcontroller while the timing microcontroller remains electrically isolated from loads powered by the streaming domain battery pack;
capturing, upon each move event, at least one board image via the camera module;
processing the at least one board image to recognize piece positions and update an internal game-state database;
encoding video and overlay metadata in the streaming single-board computer; and
transmitting a live annotated video stream including timing digits and move history to a cloud endpoint.

10. The integrated chess game capture and streaming method of claim 9, wherein the capturing comprises:
triggering board-image capture by the camera module in response to a move event indicator generated by detection, by the timing microcontroller, of an actuation of the physical push buttons.

11. The integrated chess game capture and streaming method of claim 9, wherein the processing comprises:
executing a convolutional neural network model on at the least one board image to generate a board state map that identifies a piece type and a color on each square without specialized pieces or board modifications.

12. The integrated chess game capture and streaming method of claim 9, further comprising:
evaluating each updated board state with a chess engine to generate position evaluation metrics; and
generating a natural-language commentary block tailored to a viewer skill level.

13. The integrated chess game capture and streaming method of claim 9, wherein the encoding comprises:
composing overlay metadata snippet that include remaining clock times, algebraic move notation, and evaluation bars, the overlay metadata snippet synchronized with outgoing video frames.

14. The integrated chess game capture and streaming method of claim 9, further comprising:
adjusting an active streaming parameter set comprising bitrate, resolution, and frame rate based on real-time battery state and measured network performance metrics.

15. The integrated chess game capture and streaming method of claim 9, further comprising:
storing cloud-synchronized game assets comprising an encoded video stream, a PGN move list, AI commentary, and environmental telemetry in geographically redundant object storage.

16. The integrated chess game capture and streaming method of claim 9, further comprising:
executing anti-cheating analysis that compares move-quality distributions and timing patterns to engine baselines and outputs a cheating analysis report.

17. A power system comprising:
at least two electrically isolated battery packs, each comprising dedicated charge-controller circuitry;
a first battery pack configured for exclusive supply to timing electronics including a timing microcontroller and a real-time clock chip;
a second battery pack configured for exclusive supply to streaming and camera electronics including a streaming single-board computer and a camera module;
inter-domain isolation ensuring that voltage sags in the second battery pack do not affect timing accuracy of the timing electronics; and
power management circuitry configured to provide per-domain state-of-charge information and to permit domain-selective shutdown.

18. The power system of claim 17, further comprising:
a supercapacitor-assisted burst variant comprising a supercapacitor connected in parallel with at least the second battery pack and configured to service transient high-current events.

19. The power system of claim 17, further comprising:
an inductive-charging enabled variant including a Qi-compatible receiver and an isolated fly-back converter configured to replenish any of the at least two battery packs without external connectors.

20. The power system of claim 17, wherein:
each of the at least two battery packs comprises lithium iron phosphate (LiFePO₄) cells instead of lithium-ion cells to enhance thermal stability.
